(19) United States
(12) Patent Application Publication
(10) Pub. No.: US 2026/0366638 A1
(43) Pub. Date: Nov. 19, 2026

(54) SAFETY VALVE

(71) Applicants: Fujikin Incorporated, Osaka (JP); Jtekt Corporation, Aichi (JP)

(72) Inventors: Yusei Horikawa, Osaka (JP); Masashi Matsuoka, Osaka (JP); Koji Hiramatsu, Osaka (JP); Kazushi Numazaki, Aichi (JP); Tetsuya Tokuno, Aichi (JP); Takashi Imanishi, Aichi (JP); Natsuki Iwamoto, Aichi (JP)

(21) Appl. No.: 19/487,851

(22) PCT Filed: May 28, 2024
(86) PCT No.: PCT/JP2024/019476

§ 371 Date: Nov. 25, 2025

(30) Foreign Application Priority Data
Jun. 1, 2023 (JP) 2023/090773

(51) Int. Cl. F16K 17/38

(52) U.S. Cl. CPC F16K 17/383

(57) ABSTRACT

A safety valve minimizes creep, and promotes smooth flow of, a molten fusible alloy even when a safety valve that closes a flow path presses directly on the fusible alloy. A fusible alloy 6 is disposed between a closing member 3 that blocks the flow of the fluid flowing from a discharge passage 91 of a fluid device 9 and a pressing cap 4, a reservoir 8 in which the molten fusible alloy 6 is accumulated is formed in at least one of the closing member 3 and the pressing cap 4, two plate members 5A and 5B in which holes, whose drilling positions do not overlap, are disposed between the reservoir and the fusible alloy, and a cutout portion 51, in which holes 50 of different plate members 5A and 5B communicate with each other, are formed on at least one abutment surface of the plate members.

### FIELD OF THE INVENTION

The present invention relates to a safety valve for safely discharging a fluid in a fluid device to the outside in order to prevent an excessive increase in pressure in the fluid device when an ambient temperature becomes high such as in a fire.

### BACKGROUND OF THE INVENTION

As such a safety valve, there is known a safety valve that has a fusible body that melts at a high temperature, and releases a gas in a fluid device when a movable plug body moves with melting of the fusible body, as in the patent literature referred to below.

In particular, these safety valves are attached to an open end of the discharge flow path branched from the flow path of the fluid device in which the fluid flows, and release the fluid such as the gas in the fluid device to the outside (atmosphere) when the ambient temperature rises such as when a fire occurs.

The safety valve described in Japanese patent document JP2012-132475 A is attached to an opening at an open end to the outside of a flow path branched from a fluid passage in a fluid device, seals the internal fluid so as not to leak to the outside in a normal state, and releases a gas in the fluid device when a temperature rises, thereby preventing an excessive rise in pressure in the fluid device.

The safety valve includes a cylindrical main body including a top wall and a peripheral wall, the cylindrical main body in which the lower end portion of the peripheral wall is fixed to an opening edge portion of a fluid device, a flanged columnar moving member movably disposed in the main body, a compression coil spring (elastic member) that biases the moving member upward, and a safety valve fusible body (fusible alloy) interposed between a top wall lower surface of the main body and an upper surface of the moving member. The inside of the main body communicates with the outside for the discharge passage.

Then, in the lower end portion of the peripheral wall, communication with the inside of the fluid device is blocked by the distal end of the moving member. When the fusible body is melted from this state at a high temperature such as a fire, the moving member moves to the top wall side by the biasing force of the compression coil spring, so that the inside of the main body of the safety valve communicates with the inside of the fluid device, and the fluid in the fluid device is released to the outside through the discharge passage of the main body.

In the safety valve described in Japanese patent document JP2023-132475 A, in addition to the pressing by the compression coil spring, the pressure in a container is applied to the fusible body (fusible alloy) via the moving member that blocks the flow of the fluid in the container to a discharge port. As a result, even in a predetermined temperature state, the fusible body is gradually deformed, and a phenomenon (creep phenomenon) in which the fusible body flows toward a discharge port of the fusible body in a solid state may occur. When this phenomenon progresses excessively, there is a problem that the fluid in the container may spout to the outside although a fire or the like does not occur. The term “creep” or “creep phenomenon” as used herein refers to a phenomenon in which a continuous pressing force is applied to a fusible alloy, so that the fusible alloy deformed (distorted) flows into a concave portion of a surface in contact with the fusible alloy over time.

In order to cope with such a problem, in the safety valve described in Japanese patent document JP2016-056822A, a member (valve member) that blocks the flow of the fluid in the container to the discharge port is provided separately from a moving body that presses the fusible body, and the moving directions of both members are made orthogonal to each other. With such a configuration, the valve member is locked to the moving member, and when the fusible body is melted and the moving body is immersed with an increase in temperature, the locking of the valve member with respect to the moving member is released, and the fluid in the container can be guided to the discharge port.

However, in the safety valve described in JP2016-056822A, there is a problem that the size of the entire safety valve is increased, the number of parts is large, and manufacturing cost is increased. Therefore, the present inventors have proposed a safety valve as illustrated in FIG. 8 for the purpose of providing a safety valve capable of minimizing creep of a fusible alloy even when a member that closes a flow path is a safety valve that directly presses the fusible alloy (see WIPO publication WO2022/030340). In this safety valve, a fusible alloy 6 is disposed between a closing member 3 that blocks the flow of the fluid flowing from a discharge passage 91 of a fluid device 9 and a pressing cap 4, a reservoir 8 in which the molten fusible alloy 6 is accumulated is formed in at least one of the closing member 3 and the pressing cap 4, and two plate members 59A and 59B in which the drilling positions do not overlap are disposed between the reservoir 8 and the fusible alloy 6, so that when the closing member 3 is pressed by the fluid pressure in the fluid device, the closing member 3 is not melted, but the creeped fusible alloy 6 only flows into a hole 58 of the first plate member in contact with the fusible alloy 6, and no further creep occurs.

The patent literature referred to above includes
Patent Literature 1: JP2012-132475 A
Patent Literature 2: JP2016-056822 A
Patent Literature 3: WO2022/030340

### SUMMARY OF THE INVENTION

However, although the safety valve described in WO2022/030340 has an effect of suppressing excessive creep, in a case where the fusible alloy is completely melted at the time of abnormality of occurrence of high temperature, after passing through the hole of the plate member in contact with the fusible alloy, it passes through a minute gap between two plate members in contact with each other until passing through the hole of the other plate member, and there is a problem that it takes time for the molten fusible alloy to flow out to the closing member side.

The present invention has been made in view of such a point, and an object of the present invention is to provide a safety valve capable of minimizing creep of a fusible alloy and promoting a smooth flow of a molten fusible alloy even when a member that closes a flow path is a safety valve that directly presses the fusible alloy.

A safety valve according to the present invention made to solve the above problems is a safety valve attached to a fluid device including a fluid passage therein and a discharge passage branched from the fluid passage, the safety valve including: a main body attached to an open end of the discharge passage of the fluid device, the main body forming an inflow path communicating with the discharge passage and a discharge path communicating the inflow path and an outside; and a closing member configured to block a flow of a fluid from the inflow path to the discharge path, in which the inflow path abuts on a seal portion formed at a distal end portion of the closing member and is connected to an abutment portion that blocks a flow of a fluid and an open portion having a larger diameter than the abutment portion, the open portion communicates with the discharge path and forms an attachment portion of a pressing cap that biases the seal portion of the closing member toward the abutment portion, a fusible alloy is disposed between the closing member and the pressing cap, and a reservoir in which the molten fusible alloy is accumulated is formed in at least one of the closing member and the pressing cap, and a plurality of plate members provided with holes in which drilling positions do not overlap is disposed between the reservoir and the fusible alloy, and a groove in which the holes communicate with each other is formed on at least one surface of abutment surfaces of the plate members.

In this safety valve, although the closing member is pressed by the fluid pressure in the fluid device and is not melted, the creeped fusible alloy flows into the hole of the first plate member in contact with the fusible alloy, and only slightly flows into the groove where the holes communicate with each other.

In addition, the hole provided in the plate member may have a truncated cone shape with a small diameter on the fusible alloy side. The hole has a truncated cone shape with a small diameter on the fusible alloy side, so that the molten fusible alloy smoothly flows into the groove.

According to the safety valve of the fusible plug type of the present invention, the creeped fusible alloy flows into a hole of the first plate member abutting on the fusible alloy, and slightly flows into a groove where the holes communicate with each other, but only flows into the groove, and does not advance further. Therefore, there is no problem that the safety valve malfunctions due to the creep caused by the pressure generated by the fluid pressure in the fluid device, and the groove communicating between the holes is formed on at least one of the abutting surfaces. Therefore, it is possible to provide a safety valve in which the molten fusible alloy smoothly flows from the hole of the first plate member to the hole of the second plate member and can be guided to the reservoir.

### BRIEF DESCRIPTION OF DRAWINGS

FIG. 1 illustrates a safety valve according to an embodiment of the present invention. FIG. 1a) is a front cross-sectional view illustrating a state within a predetermined temperature, and FIG. 1(b) is a front cross-sectional view illustrating a state exceeding a safety valve operating temperature.

FIG. 2 illustrates a safety valve according to another embodiment of the present invention. FIG. 2(a) is a front cross-sectional view illustrating a state within a predetermined temperature, and FIG. 2(b) is a front cross-sectional view illustrating a state exceeding a safety valve operating temperature.

FIG. 3 illustrates a plate member used in the safety valve. FIG. 3(a) is a plan view of one plate member, FIG. 3(b) is a cross-sectional view taken along line X1-X1 of the one plate member, FIG. 3(c) is a plan view of another plate member to be overlapped with the one plate member, and FIG. 3(d) is a cross-sectional view taken along line X2-X2 of FIG. 3(c).

FIG. 4 illustrates a plate member used in the safety valve. FIG. 4(a) is a perspective view of a state immediately before one plate member and the other plate member are overlapped on each other, FIG. 4(b) is a perspective view of an overlapped state, FIG. 4(c) is a cross-sectional view taken along line Y1-Y1 of FIG. 4(b), and FIG. 4(d) is a cross-sectional view taken along line Y2-Y2 of a partial cutout for explaining a creep state of a fusible alloy when the overlapped plate member is incorporated in the safety valve.

FIG. 5 illustrates another plate member used in the safety valve. FIG. 5(a) is a plan view of one plate member, FIG. 5(b) is a cross-sectional view taken along line X3-X3 of the one plate member, and FIG. 5(c) is a perspective view of a state in which the one plate member and another plate member are overlapped.

FIG. 6 illustrates another plate member used in the safety valve. FIG. 6(a) is a perspective view of one plate member, FIG. 6(b) is a cross-sectional view taken along line X4-X4 of one plate member, and FIG. 6(c) is a perspective view of a state in which the one plate member and another plate member are overlapped.

FIG. 7 illustrates another plate member used in the safety valve. FIG. 7(a) is a perspective view of one plate member, FIG. 7(b) is a cross-sectional view taken along line X5-X5 of one plate member, and FIG. 7(c) is a perspective view of a state in which the one plate member and another plate member are overlapped.

FIG. 8 illustrates a conventional safety valve. FIG. 8a) is a front cross-sectional view illustrating a state within a predetermined temperature, FIG. 8(b) illustrates two types of plate members used for the safety valve, and FIG. 8c) is a cross-sectional view when two plate members are overlapped.

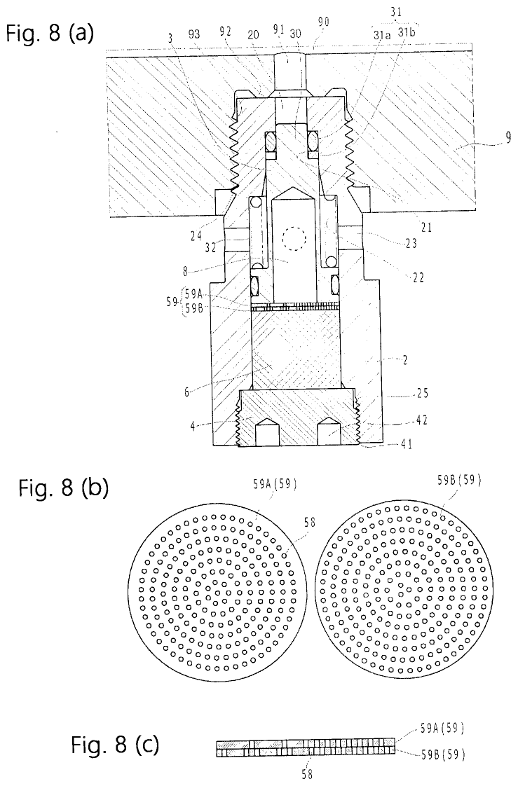

### DETAILED DESRIPTION

An embodiment of the present invention will now be described in detail with reference to drawings. Note that the following embodiment is an essentially preferable example, and is not intended to limit the scope of the present invention, the applications or the use of the present invention in any way.

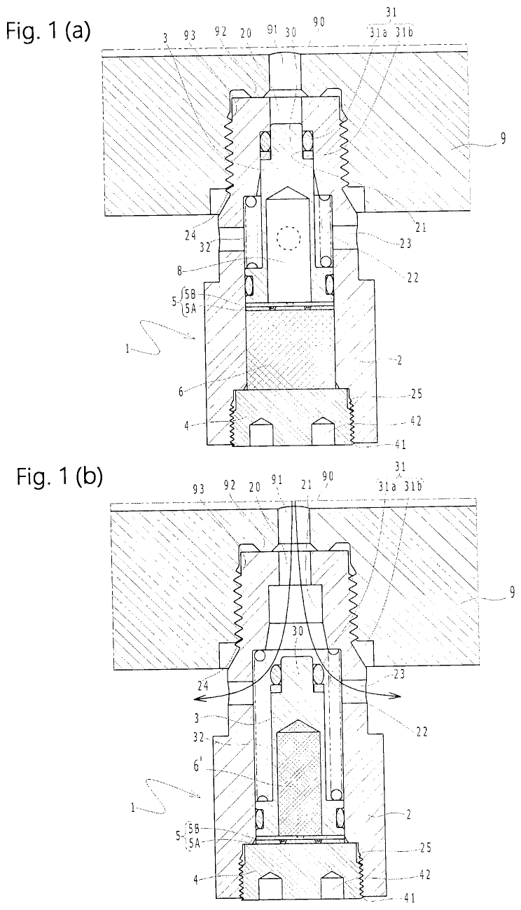

FIG. 1 illustrates a first embodiment of a safety valve of the present invention.

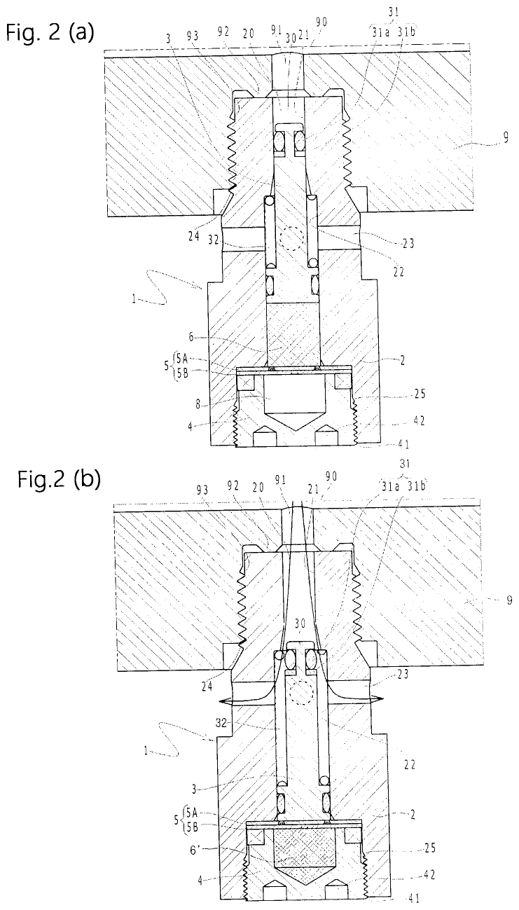

A safety valve 1, illustrated in FIGS. 1 and 2, is a safety valve attached to a fluid device 9 including a fluid passage 90 therein and a discharge passage 91 branched from the fluid passage 90. The fluid device 9 is not particularly limited, and examples thereof include a tank for storing fuel hydrogen of a fuel cell vehicle.

The safety valve 1 includes a main body 2 that is attached to the open end of the discharge passage 91 of the fluid device 9 and has an inflow path 20 communicating with the discharge passage 91 and a discharge path 23 communicating the inflow path 20 with the outside, and the closing member 3 that blocks the flow of the fluid from the inflow path 20 to the discharge path 23. The inflow path 20 abuts on a seal portion 31 formed at a distal end portion 30 of the closing member 3 and is connected to an abutment portion 21 that blocks the flow of the fluid from the discharge passage 91 of the fluid device 9 and an open portion 22 having a larger diameter than the abutment portion 21. In the present embodiment, the seal portion 31 formed at the distal end portion 30 of the closing member 3 is configured by an O-ring 31a and a backup ring 31b, but the distal end portion 30 may be formed in a truncated cone shape, and a step portion between the inflow path 20 and the abutment portion 21 may be used as a valve seat to seal a fluid. In addition, the closing member 3 is biased by an elastic member 32 such as a spring in a direction in which the inflow path 20 and the abutment portion 21 communicate with each other.

A male screw portion 24 of the safety valve 1 is screwed into a female screw portion 93 formed in a space communicating with the discharge passage 91 of the fluid device 9. This screwing is performed such that the distal end portion of the main body 2 is screwed until the distal end portion abuts on an annular protruding seal portion 92 provided at the peripheral edge of the discharge passage 91 in the space communicating with the discharge passage 91.

The open portion 22 connected to the inflow path 20 communicates with the discharge path 23 and forms an attachment portion 25 of the pressing cap 4 that fixes the seal portion 31 of the closing member 3 to the abutment portion 21. The inflow path 20, the abutment portion 21, and the open portion 22 are concentric with the axial center of the cylindrical main body 2, whereas the discharge path 23 is opened in a direction substantially orthogonal to the axial center of the main body 2.

In the pressing cap 4, a male screw portion 41 is formed on the peripheral surface, and an engagement portion 42 for engaging a tool for rotating the pressing cap 4 is formed on the top surface. In the attachment portion 25 of the main body 2, a female screw to which the male screw portion 41 formed in the pressing cap is screwed is engraved.

A fusible alloy 6 that melts when reaching a predetermined temperature is disposed between the closing member 3 and the pressing cap 4. At least one of the closing member 3 and the pressing cap 4 is formed with the reservoir 8 in which the molten fusible alloy 6 is accumulated. In FIG. 1, the reservoir 8 is formed on the closing member 3 side, and in FIG. 2, the reservoir 8 is formed in the pressing cap 4. Then, at least two plate members 5A and 5B in which drilling positions do not overlap are disposed between the reservoir 8 and the fusible alloy 6.

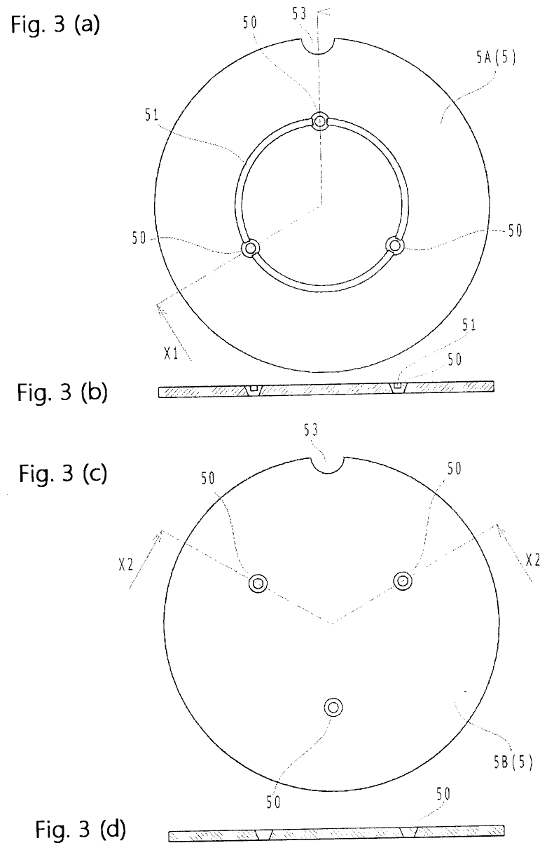

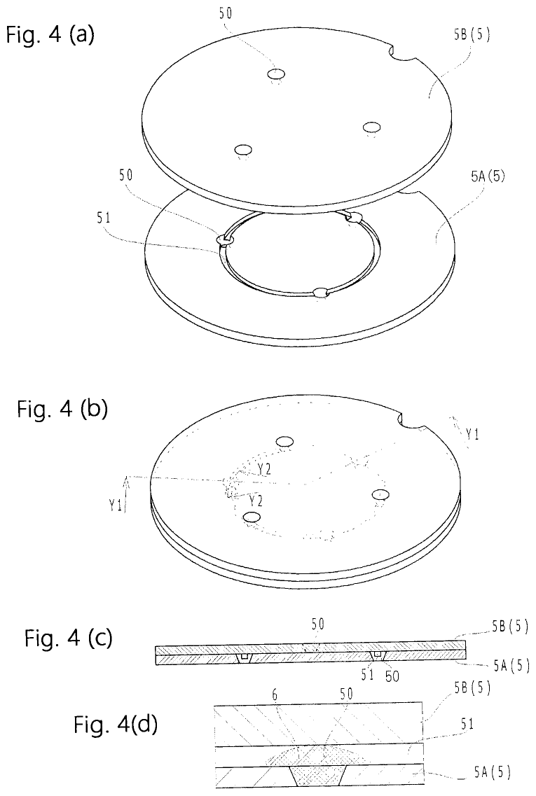

As illustrated in FIGS. 3 to 4, a plate member 5 has a plurality of holes 50 formed in a thin plate (for example, a metal plate of 0.1 to 0.5 mm). The number of holes is not particularly limited, but a plurality of holes, for example, three holes are disposed on the same radius in the present embodiment. The outer diameters of the two plate members 5A and 5B are the same, and the hole 50 is drilled on the same radius. A positioning cutout 53 is formed so that the attachment position is known so as not to be at the same position when the plate members 5A and 5B are overlapped, and marking (not illustrated) is further performed on the surface so as not to mistake the front and back.

Then, at least one of the plate members 5, that is, in the present embodiment, the plate member 5A is formed with the groove 51 communicating with each hole 50. The groove 51 of the present embodiment is an annular groove having the same radius as the distance (the same radius) from the center of the plate member 5 to each hole.

In the present embodiment, an example is illustrated in which two plate members 5A and 5B are used in an overlapping manner, but for example, three plate members may be used in the order of the plate members 5A, 5A, and 5B, but at least one groove 51 is formed on any abutment surface.

In addition, although one set of grooves 51 in which the plurality of holes 50 communicates with each other on the surface of the plate member 5 is illustrated in the drawing, a plurality of sets of grooves may be provided with different radii. Furthermore, the shape of the hole 50 has preferably a truncated cone shape in which the diameter on the fusible alloy side is small. In the plate member 5A abutting on the fusible alloy 6, the molten fusible alloy 6 spreads and flows so as to diffuse into the groove 51, so that a smooth flow of the fusible alloy can be promoted.

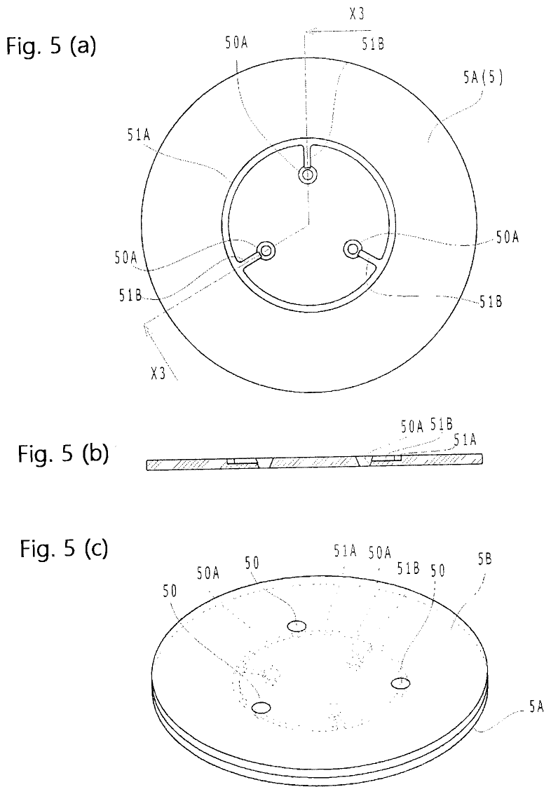

In the configuration illustrated in FIG. 5, one plate member 5A of the plate members 5 has a cutout portion 51A formed of an annular groove on a surface abutting on the other plate member 5B, and a hole 50A connected to the cutout portion 51A by a communication groove 51B at a position different from the cutout portion 51A. Then, the hole 50 is provided at a position coinciding with the cutout portion 51A formed of the annular groove in the other plate member 5B to be overlapped with the one plate member 5A, so that it is possible to prevent the drilling positions of the hole 50, 50A provided in each plate member 5 from being overlapped when the plurality of plate members 5 is overlapped without providing the above-described positioning cutout 53.

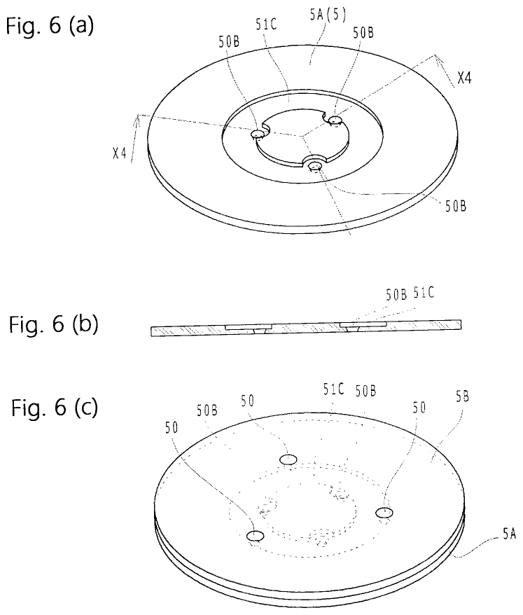

In the configuration illustrated in FIG. 6, one plate member 5A of the plate members 5 is formed with a cutout portion 51C formed of an annular groove having a width larger than the diameter of the hole 50B and a hole 50B opened to the inner peripheral side of the cutout portion 51C on a surface abutting on the other plate member 5B. Then, the other plate member 5B overlapped with the one plate member 5A is configured to have the hole 50 at a position coinciding with the outer peripheral side of the cutout portion 51C formed of the annular groove. As a result, similarly to the configuration 2, when the plurality of plate members 5 overlap each other without providing the positioning cutout 53, the drilling positions of the holes 50 and 50B provided in each plate member 5 can be prevented from overlapping.

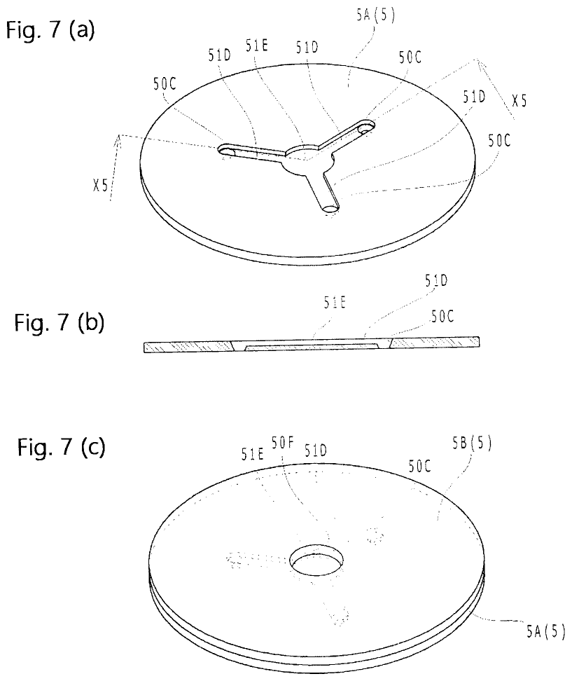

In the configuration illustrated in FIG. 7, in one plate member 5A of the plate members 5, a plurality of holes 50C, a disk-shaped cutout portion 51E drawn concentrically with the plate member 5A, and a groove-shaped cutout portion 51D connecting the hole 50C and the cutout portion 51E are formed on a surface abutting on the other plate member 5B. Then, a hole 50F having substantially the same diameter as the disk-shaped cutout portion 51E is formed at the center of the other plate member 5B overlapped with the one plate member 5A. As a result, similarly to the configuration 2, when the plurality of plate members 5 overlap each other without providing the positioning cutout 53, the drilling positions of the holes 50C and 50F provided in each plate member 5 can be prevented from overlapping.

The plate members 5 having the above configuration are combined to attach the safety valve 1 to the fluid device 9. When the fluid device 9 is operated, the fluid pressure and the pressing force of the spring are applied to the closing member 3, and the rear end side of the closing member 3 presses the fusible alloy 6 via the plate members 5A and 5B.

If this state continues for a long time, the fusible alloy 6 is not melted, but creep progresses between the fusible alloy 6 and the plate member 5A, and in the case of the plate member 5 having the configuration 1, the creep flows into the hole 50 of the plate member 5A from the state of FIG. 1, and a slight amount of the creep also flows into the groove 51 (see FIG. 4(d)).

For example, as illustrated in FIG. 4, the fusible alloy 6 flowing into the hole 50 of the plate member 5A abutting on the closing member 3 due to the creep phenomenon also flows into the groove 51, but since the groove 50 is a closed space spreading in a direction orthogonal to the pressing force for pressing the fusible alloy 6 between the groove and the second plate member 5B, further creep is suppressed, and the inflow due to the creep phenomenon remains only in a slight amount flowing into the groove 51 from the hole 50 of the first plate member 5A.

At all times, the fluid passage 90 of the fluid device 9 and the discharge passage 91 branched from the fluid passage 90 are filled with the fluid flowing in the fluid device 9, and the pressure of the fluid is applied to the distal end portion 30 of the closing member 3 of the safety valve 1 attached to the fluid device 9. Due to this pressure, the fusible alloy 6 flows into the hole 50 of the plate member 5A abutting on the fusible alloy 6 due to the creep phenomenon, and a small amount of the fusible alloy 6 also flows into the groove, but is dammed on a surface other than the hole 50 of the plate member 5B. Then, when a fire or the like occurs and the ambient temperature of the fluid device 9 exceeds a predetermined temperature (melting temperature of the fusible alloy 6), the fusible alloy 6 starts to melt.

The fusible alloy 6 that has started to melt becomes liquid, flows through the hole 50 of the plate member 5A and the groove 51 formed in the plate member 5A, passes through the hole 50 of the plate member 5B communicating with the groove 51, and flows into the reservoir 8.

When the fusible alloy 6 flows into the reservoir 8 by a predetermined amount, the closing member 3 biased toward the fusible alloy 6 by the elastic member 32 moves toward the fusible alloy 6, and the seal portion 31 formed at the distal end portion 30 is detached from an abutment portion 21 of the main body 2. As a result, the fluid in the fluid device 9 is discharged from the inflow path 20 of the safety valve 1 toward the discharge path 23 through the abutment portion 21 and the open portion 22 (see FIG. 1 (b)).

FIG. 2 illustrates another embodiment of the safety valve of the present invention.

Similarly to the first embodiment, the safety valve 1 illustrated in FIG. 2 is a safety valve attached to the fluid device 9 including the fluid passage 90 therein and the discharge passage 91 branched from the fluid passage 90. The fluid device 9 is similar to that of the first embodiment in that the fluid device 9 includes the inflow path 20 attached to the open end of the discharge passage 91 and communicating the discharge passage 91 with the outside (atmosphere), the main body 2 forming the discharge path 23, and the closing member 3 blocking and communicating both the flow passages, and the description thereof will be omitted.

The place where the reservoir 8 is formed is the closing member 3 in the safety valve 1 illustrated in FIG. 1. However, in the safety valve 1 of the present embodiment, the reservoir 8 is formed on the pressing cap 4 side. Since the diameter of the closing member 3 is large enough to secure a space in which the elastic member 32 formed of a spring or the like is disposed in the open portion 22 having a relatively small diameter, it is difficult to secure a sufficient volume when the reservoir 8 is formed in the closing member 3, but the pressing cap 4 has a relatively large diameter, and there is an advantage that the reservoir 8 having a sufficient volume can be easily formed.

Although the present invention has been described above based on the preferred embodiments thereof, the present invention is not limited to these specific embodiments, and various forms without departing from the gist of the present invention are also included in the present invention. Furthermore, each of the above-described embodiments and modifications is merely an embodiment of the present invention, and the embodiments can be appropriately combined.

### INDUSTRIAL APPLICABILITY

The safety valve of the present invention can be suitably used for a system in which the ambient temperature rapidly rises due to the occurrence of a fire or the like and the fluid in the fluid device needs to be discharged to the outside, and can be suitably used for an environmental device in which the discharge direction of the fluid to be ejected at the time of the occurrence of a fire or the like is required to be regulated by using the discharge direction regulating member to prevent the occurrence of a secondary disaster.

### REFERENCE SIGNS LIST

1 Safety valve
2 Main body
20 Inflow path
21 Abutment portion
22 Open portion
23 Discharge path
25 Attachment portion
3 Closing member
30 Distal end portion
31 Seal portion
4 Pressing cap
5 Plate member
50 Hole
51 Cutout portion
6 Fusible alloy
8 Reservoir
9 Fluid device
90 Fluid passage
91 Discharge passage

1. A safety valve attached to a fluid device including a fluid passage therein and a discharge passage branched from the fluid passage, the safety valve comprising:
a main body attached to an open end of the discharge passage of the fluid device, the main body forming an inflow path communicating with the discharge passage and a discharge path communicating the inflow path and an outside; and
a closing member configured to block a flow of a fluid from the inflow path to the discharge path;
wherein the inflow path abuts on a seal portion formed at a distal end portion of the closing member and is connected to an abutment portion that blocks a flow of a fluid and an open portion having a larger diameter than the abutment portion, the open portion communicates with the discharge path and forms an attachment portion of a pressing cap that biases the seal portion of the closing member toward the abutment portion, a fusible alloy is disposed between the closing member and the pressing cap, and a reservoir in which the molten fusible alloy is accumulated is formed in at least one of the closing member and the pressing cap, and a plurality of disk-shaped plate members each provided with a hole through which a molten fusible alloy passes is provided between the reservoir and the fusible alloy, a cutout portion in which holes of different plate members communicate with each other is formed on at least one surface of abutment surfaces of the plate members, and when the plurality of plate members is overlapped with each other, drilling positions of the holes provided in the plate members do not overlap each other.

2. The safety valve according to claim 1, wherein the cutout portion is an annular groove.

3. The safety valve according to claim 1, wherein one plate member of the plate members includes a cutout portion formed of an annular groove on a surface abutting on the other plate member, and a hole connected to a cutout portion by a communication groove at a position different from the cutout portion, and the other plate member overlapping the one plate member is provided with a hole at a position coinciding with the annular groove.

4. The safety valve according to claim 1, wherein one plate member of the plate members includes a hole drilled near an outer peripheral portion of the plate member, and the other plate member overlapped with the one plate member includes a hole having a larger diameter than the hole of the one plate member at a center of the plate member.

5. The safety valve according to any one of claims 1 to 4, wherein the hole has a truncated cone shape with a small diameter on a fusible alloy side.
